(19) United States
(12) Patent Application Publication
(10) Pub. No.: US 2022/0158572 A1
(43) Pub. Date: May 19, 2022

(54) ELECTRIFIED VEHICLE CONTROL TO DETECT STATUS OF INDIVIDUAL PHASES OF THREE-PHASE MOTOR

(71) Applicant: Ford Global Technologies, LLC, Dearborn, MI (US)

(72) Inventors: Xuemei SUN, Canton, MI (US); Papiya BAGCHI, Northville, MI (US); Rimma PARANSKY, Farmington Hills, MI (US); Anish DASARI, Farmington Hills, MI (US); Vishal SRIVASTAVA, Grass Lake, MI (US)

(73) Assignee: Ford Global Technologies, LLC, Dearborn, MI (US)

(21) Appl. No.: 16/951,742

(22) Filed: Nov. 18, 2020

(51) Int. Cl. H02P 1/42; B60L 3/00; H02P 1/30; H02P 29/024

(52) U.S. Cl. CPC H02P 1/423; H02P 29/0241; H02P 1/30; B60L 3/0023

(57) ABSTRACT

An electrified vehicle includes a traction battery, an inverter coupled to the traction battery and operable to convert direct current (DC) power from the traction battery to three-phase alternating current (AC) power, a three-phase electric machine coupled to the inverter by associated cables, a sensor configured to generate a signal associated with rotational position of a rotor of the three-phase electric machine, a current sensor associated with each cable/phase of the three-phase electric machine, and a controller programmed to generate non-zero phase current at each of a plurality of predetermined regularly spaced rotational positions by either adjusting rotor angle or injecting q-axis current, command the inverter to inject a test current pulse to the electric machine, and generate a diagnostic signal in response to any one of the current sensor signals being less than an associated threshold to detect a cable or current sensor anomaly in a single phase.

### TECHNICAL FIELD

This disclosure relates to the control of an electrified vehicle to detect an open circuit or current sensor anomaly associated with any one of the phases of a three-phase motor.

### BACKGROUND

An electrified vehicle such as a hybrid-electric vehicle (HEV) or all-electric vehicle (EV) has a traction battery to store and provide energy for vehicle propulsion. Electrified vehicles include high voltage components such as a high voltage (HV) traction battery and traction motor. Electrified vehicles may include a high voltage interlock system that applies a lower voltage pulse to monitor the integrity of DC cable connections and circuits before applying high voltage power, such as disclosed in U.S. Pat. No. 9,550,422, for example. The electric machine that functions as the traction motor is typically a three phase AC machine connected by three power cables to a power inverter powered by the HV battery that converts the power from DC to AC. The AC cables and circuits may not be monitored by the HV interlock system. In applications that do monitor the AC circuits and connections, some only detect anomalous conditions occurring in two or more of the connections or associated sensors. As such, if a single cable or single current sensor becomes loose, disconnected, or otherwise exhibits anomalous operation, this condition may not be detected.

### SUMMARY

An electrified vehicle includes a traction battery, an inverter coupled to the traction battery and operable to convert direct current (DC) power from the traction battery to three-phase alternating current (AC) power, a three-phase electric machine coupled to the inverter by associated cables, a sensor configured to generate a signal associated with rotational position of a rotor of the three-phase electric machine, a current sensor associated with each cable/phase of the three-phase electric machine, and a controller programmed to adjust rotor measurement or inject q-axis current at each of a plurality of predetermined regularly spaced rotational positions associated with zero phase current, to command the inverter to inject a test d-axis current pulse to the electric machine, and generate a diagnostic signal in response to any one of the current sensor signals being less than an associated threshold to detect a cable or current sensor anomaly in a single phase. The controller may apply a position offset to the signal from the sensor to position the rotor angle away from each of the plurality of predetermined positions. The position offset may be non-zero for rotational positions of the rotor approaching the predetermined positions and zero otherwise. This ensures the generated three phase current has non-zero magnitude at each of the regularly spaced rotational positions spaced sixty degrees from an adjacent one of the regularly spaced rotational positions. The test current pulse may have a current less than a maximum current threshold associated with initiation of vehicle motion, and exceed a minimum current threshold determined based on a phase current generated by the current pulse in each phase of the three-phase electric machine exceeding a minimum detectable current associated with the corresponding current sensor for each phase.

Embodiments may include an electrified vehicle having a traction battery coupled by an inverter connected to a three-phase electric machine by associated cables with each cable having an associated current sensor, comprising a controller configured to apply a position offset to the sensing signal from a rotational position sensor of the three-phase electric machine, to inject a test current to the three-phase electric machine, and to generate a diagnostic signal in response to a signal from the current sensor for any one of the cables being below an associated threshold while injecting the test current. The controller may apply the position offset in response to rotational position of the three-phase electric machine being within a predetermined range of a zero-phase-current rotational position associated with zero phase current in one of the three-phases. The position offset may be greater than zero as the rotational position are near to the zero-phase-current rotational position, and zero otherwise. The controller may be further configured to apply the test current in response to detection of traction battery voltage being applied to the inverter. The test current may be insufficient to induce vehicle motion, while generating a current in each of the cables above a minimum detection threshold of the associated current sensor.

Embodiments may also include a method for controlling an electrified vehicle having a traction battery coupled to an inverter connected to a three-phase electric machine by associated cables with each cable having an associated current sensor, comprising, by a controller in response to detecting traction battery voltage applied to the inverter: controlling rotational position of the three-phase electric machine to avoid rotational positions having zero phase current in one of the three phases; controlling the inverter to inject a test current to the three-phase electric machine; and generate a diagnostic signal in response to the current sensor for any one of the three cables indicating current less than an associated threshold while injecting the test current. The method may include controlling rotational position by applying an offset to the measurement from a position sensor configured to detect rotational position of the three-phase electric machine. The offset may be non-zero relative to the zero phase current positions, and zero otherwise .

One or more embodiments according to the disclosure may have associated advantages. For example, embodiments may be able to detect disconnection of a single AC cable connecting an electric machine to the converter, or anomalous operation of a single current sensor.

### BRIEF DESCRIPTION OF THE DRAWINGS

FIG. 1 is block diagram of an electrified vehicle implemented as a hybrid-electric vehicle.

FIG. 2 is a block diagram illustrating connections between an HV traction battery and an electric machine (motor/generator) of a representative electrified vehicle.

FIG. 3 is a diagram illustrating the relationship between a three-phase complex coordinate system and associated two-phase representations with direct and quadrature axes for electric machine position control and anomaly detection.

FIG. 4 is a block diagram illustrating a control system for electric machine control and anomaly detection in a single phase of a three-phase electric machine.

FIG. 5 is a plot illustrating an electric machine position offset to (n*60) deg angle where zero-phase-current may be generated.

FIG. 6 is a plot illustrating a relationship between an injected rotor position to avoid ambiguous phase current measurement and rotor position offset to (n*60) deg rotor angle during a diagnostic test of phase currents.

FIG. 7 is a plot illustrating electric machine rotor position and associated new position after a position offset in FIG. 6 is added the position measurement.

FIG. 8 is a flowchart illustrating entry conditions of a system or method for anomaly detection in a single phase of a three phase electric machine.

FIG. 9 is a state diagram illustrating operation of a system or method for anomaly detection in a single phase of a three phase electric machine.

### DETAILED DESCRIPTION

Embodiments of the present disclosure are described herein. It is to be understood, however, that the disclosed embodiments are merely examples and other embodiments can take various and alternative forms. The figures are not necessarily to scale and may be simplified; some features could be exaggerated, minimized, or omitted to show details of particular components. Therefore, specific structural and functional details disclosed herein are not to be interpreted as limiting, but merely as a representative basis for teaching one skilled in the art to variously employ the claimed subject matter. As those of ordinary skill in the art will understand, various features illustrated and described with reference to any one of the figures can be combined with features illustrated in one or more other figures to produce embodiments that are not explicitly illustrated or described, but within the scope of the claimed subject matter. The combinations of features illustrated provide representative embodiments for typical applications. Various combinations and modifications of the features consistent with the teachings of this disclosure, however, could be desired for particular applications or implementations.

Electrified vehicles contains high voltage components such as a high voltage traction battery and traction motor. Vehicles may include a high voltage interlock system to ensure DC cable connection integrity prior to operating switches or contactors to apply the high voltage from the battery to vehicle components. The traction motor control system may include the traction motor or electric machine, inverter control circuitry, transmission gear sets, etc. The control path (motor phase cable connection, inverter control circuit, and current sensor) may be checked at power up to detect any anomalies. However, traction motor AC cables are often not included in the HV DC interlock detection. Three AC power cables connect the electric machine (motor and/or generator) phases to the power inverter. One or more AC cables can get disconnected at various points between the machine and the inverter resulting in the electric propulsion system being disabled. In many instances, only a single cable becomes disconnected. Various embodiments of the disclosure detect this condition in a single one of the three phase cables or associated current sensors and generate a diagnostic code that may alert the operator and assist service personnel in identifying and correcting the condition.

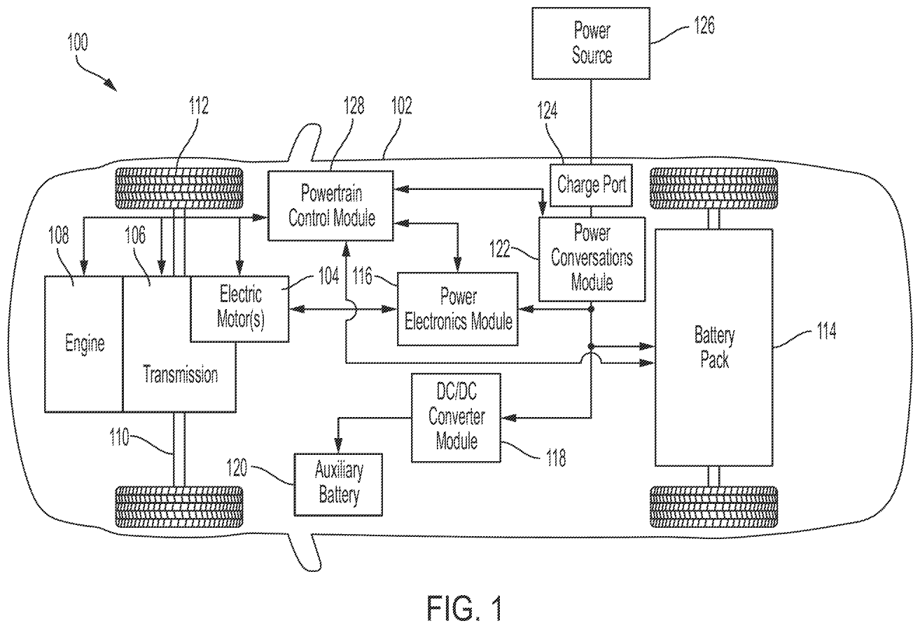

FIG. 1 depicts an example of an electrified vehicle 100 implemented as a plug-in hybrid-electric vehicle. The electrified vehicle 100 may comprise one or more three-phase electric machines 104 mechanically connected to a transmission 106. In addition, the transmission 106 is mechanically connected to an engine 108 for hybrid implementations. The transmission 106 may also be mechanically connected to a drive shaft 110 that is mechanically connected to the wheels 112. The electric machines or motor/generators 104 can provide propulsion whether the engine 108 is turned on or off. The electric machines 104 can also provide deceleration capability. The electric machines 104 may operate as motors, generators, or both and can provide fuel economy benefits by recovering energy that would normally be lost as heat. Electrified vehicle 100 may also be implemented as a battery electric vehicle without an engine 108 and powered solely by traction battery 114.

Traction battery or battery pack 114 stores energy that can be used by the electric machines 104. A vehicle battery pack 114 typically provides a high voltage (HV) DC output provided by connecting hundreds of low voltage cells together. The battery pack 114 is electrically connected to a power electronics module 116. The power electronics module 116 is also electrically connected to the electric machines 104 and provides the ability to bi-directionally transfer energy between the battery pack 114 and the electric machines 104. For example, a typical battery pack 114 may provide a DC voltage/current while the electric machines 104 may require a three-phase AC voltage/current. The power electronics module 116 may convert the DC voltage to a three-phase AC current as required by the electric machines 104 and may also be referred to as an inverter in various applications. In a regenerative mode, the power electronics module 116 will convert the three-phase AC current from the electric machines 104 acting as generators to the DC voltage required to recapture energy in the battery pack 114.

In addition to providing energy for propulsion, the battery pack 114 may provide energy for other vehicle electrical systems. A typical system may include a DC/DC converter module 118 that converts the high voltage DC output of the battery pack 114 to a low voltage DC supply that is compatible with other vehicle loads. Other high voltage loads, such as compressors and electric heaters, may be connected directly to the high-voltage bus from the battery pack 114. In a typical vehicle, the low voltage systems are electrically connected to a 12V, 24V, or 48V battery 120. An all-electric vehicle may have a similar architecture but without the engine 108.

The battery pack 114 may be recharged by an external power source 126. The external power source 126 may provide AC or DC power to the vehicle 102 by electrically connecting through a charge port 124. The charge port 124 may be any type of port configured to transfer power from the external power source 126 to the vehicle 102. The charge port 124 may be electrically connected to a power conversion module 122, sometimes referred to as a charger or charging module. The power conversion module may condition the power from the external power source 126 to provide the proper voltage and current levels to the battery pack 114. In some applications, the external power source 126 may be configured to provide the proper voltage and current levels to the battery pack 114 and the power conversion module 122 may not be necessary. The functions of the power conversion module 122 may reside in the external power source 126 in some applications. The vehicle engine, transmission, electric machines, battery, power conversion, power electronics, and various other control modules, components, or systems may be controlled by a powertrain control module (PCM) 128. Alternatively, or in combination, various systems or subsystems may include associated control modules or controllers in communication with PCM 128 over a vehicle wired or wireless network to provide coordinated control of the vehicle.

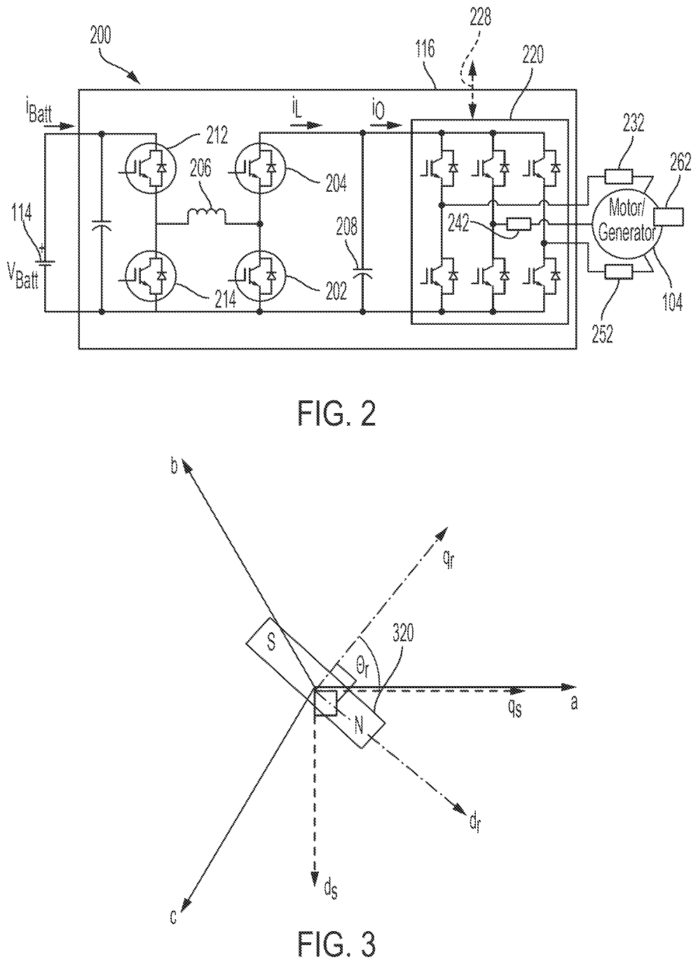

FIG. 2 illustrates a traction battery 114 coupled to a power electronics module 116 connected to a three-phase electric machine 104 in a representative electrified vehicle 100. One or more contactors or high voltage switches controlled by an associated controller, such as powertrain control module 128, may be operated to selectively connect battery voltage from battery 114 to power electronics module 116 after completing various diagnostic routines in response to a vehicle start. These high voltage switches may be implemented by relays, insulated gate bipolar junction transistors (IGBTs), metal oxide semiconductor field effect transistors (MOSFETs), bipolar junction transistors (BJTs), and/or other electro-mechanical or solid state switches. The system may include a pre-charge circuit to limit the current flow from battery 114 while the system is powering up.

Power electronics module 116 may include buck-boost converter circuitry 200 upstream of inverter components 220 to drive one or more electric machines 104. The power electronics module 116 may include a boost circuit with an inductor 206, a switch 212 to charge an electric field in the inductor 206, and a switch 214 to discharge the electric field and change the voltage to drive the motor/generator 104. This power electronics module 200 may also include a buck circuit using inductor 206 and switches 202 and 204. This DC/DC convertor circuit will convert the battery voltage to an operational voltage which may be greater than the battery terminal voltage. The buck-boost power converter 200 may use IGBTs, BJTs, MOSFETs, relays, or other electro-mechanical or solid state switches. The use of IGBTs with Fast Recovery Diodes (FRDs) in this diagram is exemplary and may be accomplished using MOSFETs, BJTs, or other electro-mechanical or solid state switches. The capacitor 208 is used to filter the voltage generated by the DC/DC convertor so that the operational voltage applied to the inverter 220 is generally stable. This buck-boost circuit is intended to change the voltage of a high voltage battery 114 (having a voltage greater than 60V DC), to an operating voltage different than the battery voltage. An example of this is a high voltage battery of 90-400 volts being changed to an operating voltage of 100-1200 volts.

As previously described, inverter 220 converts the DC voltage/current to a three-phase AC voltage/current provided to electric machine 104. As described in greater detail herein, inverter 220 communicates with an associated controller as indicated at 228 to receive a command to inject a test current pulse to electric machine 104 to evaluate proper connection and functioning of cables and current sensors 232, 242, 252 associated with each phase of the electric machine 104. Electric machine 104 may include a resolver or other rotational position sensor 262 that provides a corresponding signal indicative of rotational position of the rotor of electric machine 104. The rotational position sensor 262 may communicate with an associated controller or processor that performs feedback control of rotor position and related current commands for inverter 220 to deliver to each phase of electric machine 104 to control associated torque.

FIG. 3 is a diagram illustrating the relationship between a three-phase complex coordinate system and associated two-phase representation with direct and quadrature axes for electric machine control and anomaly detection according to one or more embodiments. Electric machines such as the motor/generator 104 include a rotor 320 that rotates within the magnetic field of a stator. The rotor parameters, such as three phase current, can be mathematically represented relative to a three-phase stationary frame a, b, and c, or alternatively in two dimensions via a stationary direct (d), quadrature (q) frame and a rotating d, q frame. For example, the stationary d, q frame includes a direct axis dₛ and a quadrature axis qₛ, and the rotating d, q frame includes a direct axis dᵣ and a quadrature axis qᵣ. The rotating d, q frame is aligned with movement of the rotor 320. Therefore, θr represents an angular position of the rotor 320. The angular position Or of the rotor 320 may be used to calculate the instantaneous current commands iₐ, i_{b}, and i_{c} for each of the three-phases (a, b, c) to control torque of the electric machine 104. A signal representing the angular position of the rotor may be provided to the controller by an associated sensor 262 (FIG. 2).

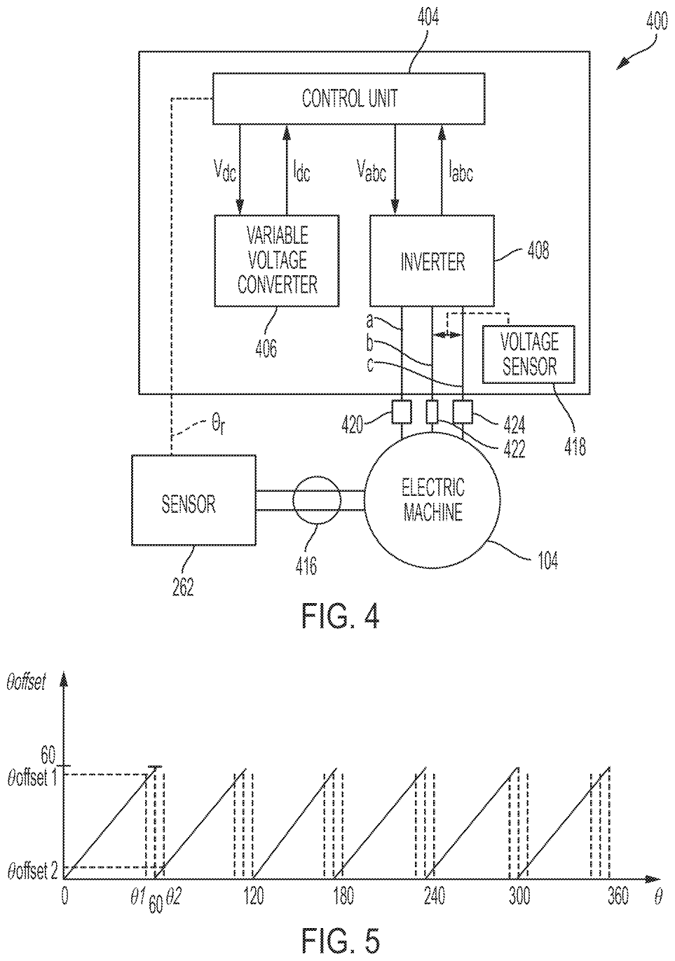

FIG. 4 illustrates a rotor position detection and control system 400 of a representative electrified vehicle, such as the electric vehicle 100 shown in FIG. 1. In one embodiment, the rotor position system 400 includes a rotational position sensor 262, a control unit 404, a variable voltage converter 406, and an inverter 408. The control unit 404 may include a programmable microprocessor and associated memory and circuitry to implement a closed loop feedback control algorithm or strategy to control the current of the stator of electric machine 104 by adjusting an measured rotor position. Control unit 404, variable voltage converter 406, and inverter 408 may be part of the controller 400 or could be separate from the controller 400.

The rotational position sensor 262 may be a resolver, encoder, speed sensor, or another position sensor that is associated with the electric machine 104. The sensor 262 monitors an angular or rotational position of the rotor (or shaft) of the electric machine 104. The sensor 262 may be mounted to or separate from the rotor. The sensor 262 communicates signals or information to the control unit 404 based on rotational or angular position of the rotor or connected shaft. System 400 may include a current sensor

The rotor position detection and control system 400 may use algorithms programmed into the control unit 404 to apply voltage commands and process the feedback signals from sensor 262 to determine the rotor position and apply a rotor position offset during diagnostic testing with the vehicle stationary according to various embodiments. For example, the control unit 404 may control 3-phase current to the electric machine 104 based on a commanded injected current test pulse to command 3-phase voltages V_{abc} for output by the inverter 408 and measuring the phase current I_{abc} in each phase as detected by an associated current sensor 420, 422, 424 and rotor position θr as feedback. One or more voltage sensors 418 may also be provided to measure a voltage across associated pairs of windings of the electric machine 104.

Applying a rotor position offset to the signal from sensor 262 may be used to adjust the rotor position measurement during testing and avoid rotor positions that would have zero phase current. These positions are regularly spaced at sixty degree intervals in one embodiment. The number of positions and associated spacing may vary based on the particular design of the electric machine 104. Control unit 404 or another controller may monitor phase current in each of the three phases to detect any anomalies in operation of current sensors 420, 422, 424 and/or cable connections from the inverter 408 to the electric machine 104. Avoiding rotor positions associated with zero phase current provides more robust detection of an anomaly in a single one of the phases (cable or sensor) as compared to various prior art strategies that may only reliably detect concurrent anomalies in two or more cables/sensors. A poor cable connection or intermittent current sensor operation in a single phase may result in inaccurate torque output or fluctuations in torque produced by electric machine 104.

The diagnostic strategy to detect a single phase HV AC cable or current sensor anomaly is based on recognition that the phase current will be close to 0 A when the HV AC phase cable is loosely connected or disconnected. As such, embodiments of the disclosure inject a test current pulse to the motor stator and monitor the measured phase current in each phase relative to a threshold (greater than 0 A). A short test current pulse is used to avoid producing vehicle motion when all cables are properly connected.

For a three-phase electric machine, the commanded phase current in each phase can be calculated using an inverse Park and Clarke Transformation as shown below.

$$( \begin{matrix}{i}_{acmd} \\ {i}_{bcmd} \\ {i}_{ccmd}\end{matrix} ) = ( \begin{matrix}sin θ & cos θ & 1 \\ sin ( θ - 12 {0}^{0} ) & cos ( θ - 12 {0}^{0} ) & 1 \\ sin ( θ + 12 {0}^{0} ) & cos ( θ + 12 {0}^{0} ) & 1\end{matrix} ) ( \begin{matrix}{i}_{edscmd} \\ {i}_{eqscmd} \\ 0\end{matrix} )$$

where (1) i_{acmd}, 1_{bcmd} and i_{ccmd} are instantaneous three-phase electric machine stator current commands in complex space vector; (2) i_{edscmd} and i_{eqscmd} are the instantaneous current commands in the orthogonal two coordinate axes, considering the electric machine as a two-phase machine for simplification; and (3) θ is the angle between the quadrature axis of the stationary reference frame (qₛ) attached to the stator and the quadrature (real) axis (qᵣ) of the rotating frame (i_{edscmd} being the direct component and i_{eqscmd} being the quadrature component in the rotating orthogonal frame.)

When the test current pulse is applied, i_{eqscmd}=0. Based on the transformation equation above, the commanded phase current depends on the rotational/angular position of the electric machine rotor. For example, at 0° rotor angular position a zero phase current would result whether or not the associated cable is connected for that phase, i.e. it is difficult or impossible to reliably determine whether the 0 A phase current is a result of the commanded phase current or because a cable is disconnected or associated current sensor is inoperative. The table below summarizes the motor rotor positions where injecting a test current pulse is not robust for cable monitoring and detection.

| θ | i_{acmd} | i_{bcmd} | i_{ccmd} | |
|---|---|---|---|---|
| [deg] | [A] | [A] | [A] | |
| 0 | 0 | 52 | −52 | unable to detect phase A |
| | | | | cable/current sensor anomaly |
| 60 | −52 | 52 | 0 | unable to detect phase C |
| | | | | cable/current sensor anomaly |
| 120 | −52 | 0 | 52 | unable to detect phase B |
| | | | | cable/current sensor anomaly |
| 180 | 0 | −52 | 52 | unable to detect phase A |
| | | | | cable/current sensor anomaly |
| 240 | 52 | −52 | 0 | unable to detect phase C |
| | | | | cable/current sensor anomaly |
| 300 | 52 | 0 | −52 | unable to detect phase B |
| | | | | cable/current sensor anomaly |

As such, injecting a diagnostic test Id current pulse alone is unable to robustly detect phase cable or current sensor anomalies at motor rotor angular positions corresponding to (60°* n), where n=0, 1, 2, 3, 4, 5. To improve the robustness of monitoring and anomaly detection, embodiments according to the disclosure avoid the plurality of regularly spaced rotor positions corresponding to (60°* n) motor position by injecting or otherwise applying a position offset to the rotor position signal of the feedback controller as described herein. Another method may be to inject a small Iq pulse on top of Id pulse when position angle is close (60°*n). Both methods have same effect and angle injection will be described in detail below.

According to one or more embodiments, the position offset to position (60°* n) can be calculated as Equation (1):

$${θ}_{offset} = θ - ( \frac{θ}{6 {0}^{0}} ) * 6 {0}^{0} \qquad ( 1 )$$

The offset may be asymmetrical with respect to the zero-phase-current position. For example, when the rotor position is within a predetermined range or neighborhood of the zero-phase-current position of (60°* n), θ_{offset} has a large value when approaching (60°* n) and a small after passing the zero-phase-current position. A representative example of asymmetrical offset values is provided in the table below and illustrated graphically in FIG. 5.

| θ | 0 | 4 | 56 | 60 | 64 | 116 | 120 | 124 | 176 | 180 | 184 | 236 | 244 | 296 | 300 | 304 | 356 |
|---|---|---|---|---|---|---|---|---|---|---|---|---|---|---|---|---|---|
| θ_{offset} | 0 | 4 | 56 | 0 | 4 | 56 | 0 | 4 | 56 | 0 | 4 | 56 | 4 | 56 | 0 | 4 | 56 |

FIG. 5 is a graphical representation of a rotor position offset to (60°* n) as a function of rotor position. In the plot of FIG. 5, θ represents the angular or rotational position of the electric machine rotor/shaft and θ_{offset} represents the position offset in degrees calculated using equation (1) above.

The injected angle can be calculated according to equation (2) below:

$${θ}_{inject} = \{ \begin{matrix}HviPosDt - {θ}_{offset} & if {θ}_{offset} \leq HviPosDt \\ 6 {0}^{0} - HviPosDt - {θ}_{offset} & if ( 6 {0}^{0} - HviPosDt ) \leq {θ}_{offset} \leq 6 {0}^{0} \\ 0 & otherwise\end{matrix} \qquad ( 2 )$$

where HviPosDt is a calibration parameter having a value chosen to generate sufficient phase current for robust detection by an associated current sensor, but not result in vehicle motion. As an example, at motor position (θ)=0° and with a diagnostic test injected current pulse of −60 A, HviPosDt=5° will generate a phase current of about 5.2 A in phase current command based on the previously described transformation equation. If a representative current sensor resolution or detection minimum threshold is assumed to be near 3 A, this current injection is sufficient to distinguish whether phase A cable is disconnected or not. Stated differently, if the current measured by the corresponding phase current sensor is below the threshold of 3 A, then a diagnostic signal or code is generated indicating an anomaly in the associated phase cable or current sensor. A graphical representation of the relationship between the injected position offset θ_{injected} calculated according to equation (2) with a value for HviPosDt=5° as a function of θ_{offset} position offset calculated using equation (1) is graphically illustrated in FIG. 6.

The new position is then calculated as shown below:

$${θ}_{new} = \{ \begin{matrix}θ + ( HviPosDt — {θ}_{offset} ) & if {θ}_{offset} \leq HviPosDt \\ θ + ( 6 {0}^{0} - HviPosDt - {θ}_{offset} ) & if ( 6 {0}^{0} - HviPosDt ) \leq {θ}_{offset} \leq 6 {0}^{0} \\ θ & otherwise\end{matrix} \qquad ( 3 )$$

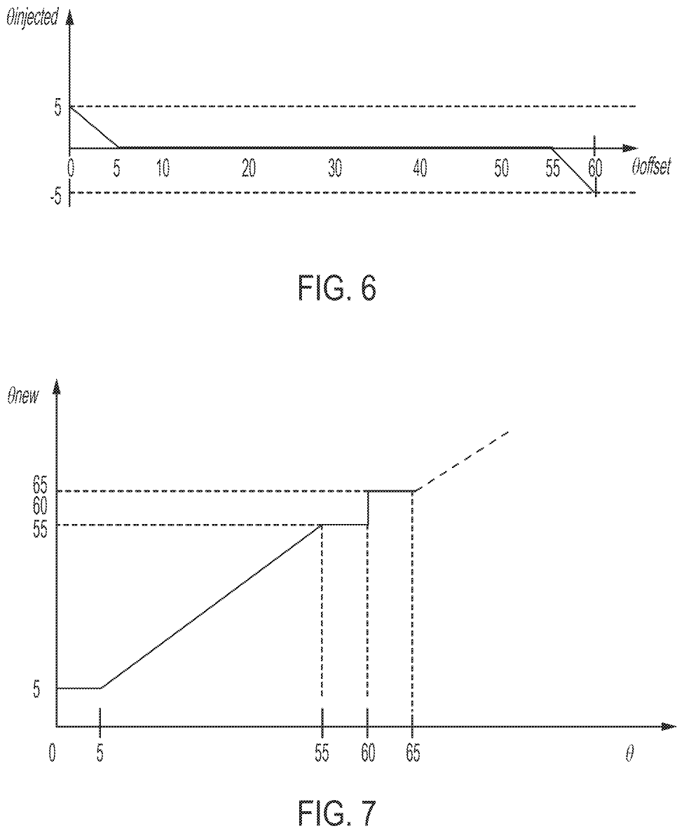

A graphical representation of θ_{new} as a function of θ with HviPosDt=5° is illustrated in FIG. 7 where θ represents the measured angular rotor position in degrees and θ_{new} represents the adjusted angular position in degrees calculated from equation (3).

The values for the position offset to (60°*n), the injected angle, and the new position at representative rotor positions with HviPosDt=10° are provided in the table below:

| θ | 0 | 4 | 56 | 60 | 64 | 116 | 120 | 124 | 176 | 180 | 184 | 236 | 240 | 244 | 296 | 300 | 304 | 356 |
|---|---|---|---|---|---|---|---|---|---|---|---|---|---|---|---|---|---|---|
| θ_{offset} | 0 | 4 | 56 | 0 | 4 | 56 | 0 | 4 | 56 | 0 | 4 | 56 | 0 | 4 | 56 | 0 | 4 | 56 |
| θ_{new} | 10 | 10 | 50 | 70 | 70 | 110 | 10 | 130 | 170 | 190 | 190 | 230 | 250 | 250 | 290 | 310 | 310 | 350 |
| θ_{inject} | 10 | 6 | −6 | 10 | 6 | −6 | 10 | 6 | −6 | 10 | 6 | −6 | 10 | 6 | −6 | 10 | 6 | −6 |

As demonstrated by the tables above and FIGS. 5-7, injecting an additional resolver position offset according to embodiments of the disclosure results in a new rotor position that avoids the zero-phase-current rotational positions corresponding to (60°*n) to provide robust cable and current sensor monitoring capable of detecting an anomaly in any one of the three phase cables or current sensors.

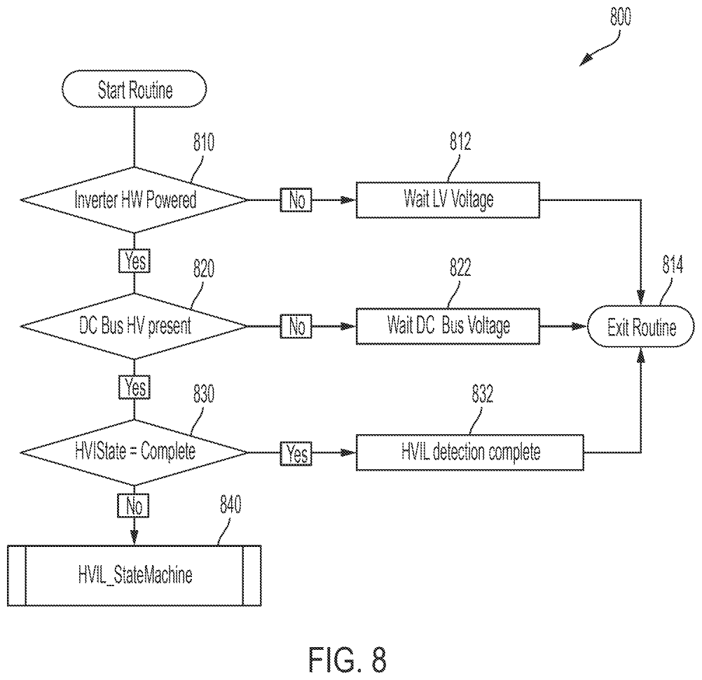

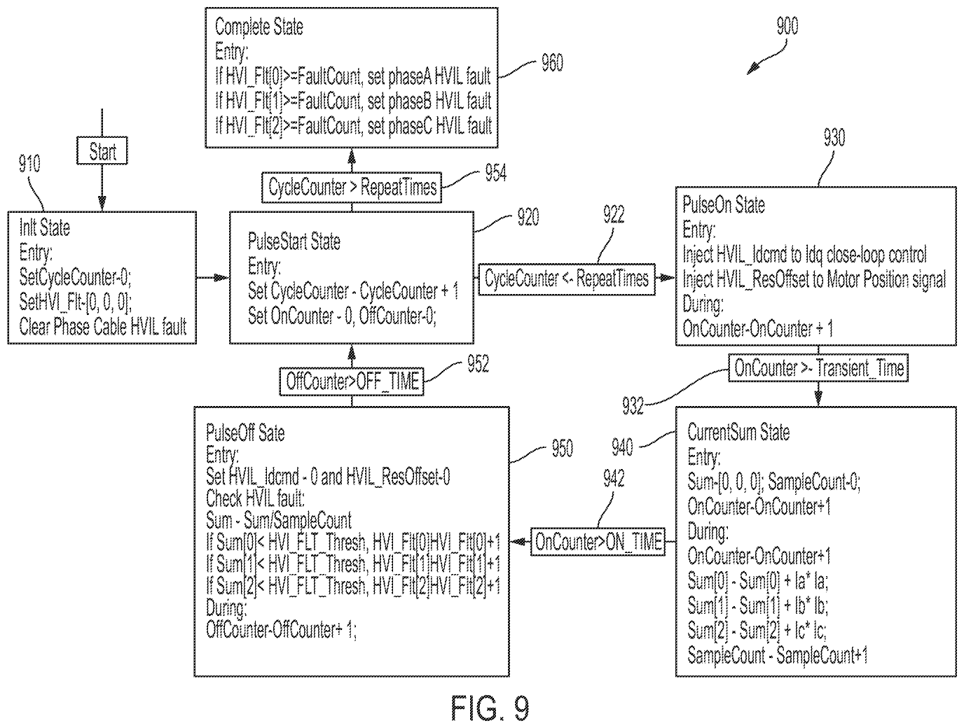

FIG. 8 is a flowchart illustrating entry conditions of a system or method for anomaly detection in a single phase of a three phase electric machine. Process 800 may be triggered when the vehicle is stationary, in response to a predefined condition or event such as a vehicle “key-on” or start, in response to a diagnostic command from a corresponding service tool, etc. If the inverter hardware is powered at 810, the process proceeds to 820. Otherwise low voltage is indicated as represented at 812 and the routine is exited at 814. If battery voltage or high voltage (HV) is applied to the DC bus at 820, then the process proceeds to 830. Otherwise, insufficient DC bus voltage is indicated as represented at 822 and the routing is exited at 814. If the diagnostic test has not yet been performed as represented at 830, then the diagnostic test starts as represented by the state machine of FIG. 9 as represented at 840. Otherwise, the HV interlock diagnostic detection is completed as indicated at 832 and the routine is exited as indicated at 814.

FIG. 9 is a state machine or state transition diagram illustrating operation of a system or method for anomaly detection in a single phase of a three phase electric machine. State machine 900 includes an initialization state 910 that resets associated counters and clears any previously set diagnostic signal or code before transitioning to the injection current pulse start state at 920 where corresponding pulse on/off counters are reset and a cycle counter is incremented. If the cycle counter is less than the programmed number of repetitions as indicated at 922, the state transitions to the pulse on state 930 wherein the controller commands a test current injection pulse for the closed loop electric machine control. In addition, a resolver offset is applied or injected to the machine rotor position signal as previously described so the rotor is positioned to avoid the zero-phase-current command positions. The pulse time counter is incremented until it exceeds a programmed transient time to allow the command pulse to generate a stable phase current in each of the phases as indicated at 932. The phase currents in each phase cable are monitored in current sum state 940 based on corresponding signals from the associated current sensors. State 932 further calculates for each phase the sum of the phase current squared.

State machine 900 transitions from the current sum state 940 to the pulse off state 950 when the test pulse counter exceeds the corresponding programmed on time of the pulse duration as indicated at 942. Pulse off state 950 terminates the current injection pulse and resolver or position sensor offset and compares each phase current sum to an associated threshold. If a phase current is below the associated minimum threshold, a diagnostic signal or count is incremented for each cycle. State 950 transitions back to state 920 when the off counter exceeds the corresponding programmed off time at 952. The states 920, 930, 940, and 950 may be repeated multiple times to obtain corresponding sample current data to minimize the effect of transient anomalies until the cycle counter exceeds the programmed number of cycles as indicated at 954 to enter the complete state 960. The complete state 960 then generates a diagnostic signal and/or stores a corresponding diagnostic code if any one of the phases has a diagnostic count exceeding a corresponding threshold indicating a likely persistent anomaly in a particular phase cable or current sensor.

The processes, methods, or algorithms disclosed herein can be deliverable to/implemented by a processing device, processor, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as RAM devices, FLASH devices, MRAM devices and other non-transitory optical media. Alternatively, the processes, methods, or algorithms can be embodied in whole or in part using suitable hardware components, such as Application Specific Integrated Circuits (ASICs), Field-Programmable Gate Arrays (FPGAs), state machines, controllers, or any other hardware components or devices, or a combination of hardware, software and firmware components. While the algorithms, processes, methods, or steps may be illustrated and/or described in a sequential matter, various steps or functions may be performed simultaneously or based on a trigger or interrupt resulting in a different sequence or order than illustrated and described. Some processes, steps, or functions may be repeatedly performed whether or not illustrated as such. Similarly, various processes, steps, or functions may be omitted in some applications or implementations.

The representative embodiments described are not intended to encompass all possible forms within the scope of the claims. The words used in the specification are words of description rather than limitation, and it is understood that various changes can be made consistent with the teachings of the disclosure within the scope of the claimed subject matter. As previously described, one or more features of various embodiments can be combined to form further embodiments that may not be explicitly described or illustrated. Although embodiments that have been described as providing advantages over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electrified vehicle comprising:
a traction battery;
an inverter coupled to the traction battery and operable to convert direct current (DC) power from the traction battery to three-phase alternating current (AC) power;
a three-phase electric machine coupled to the inverter;
a sensor configured to generate a signal associated with rotational position of a rotor of the three-phase electric machine;
a current sensor associated with each phase of the three-phase electric machine; and
a controller programmed to:
generate non-zero phase current at each of a plurality of predetermined regularly spaced rotational position by either adjusting the rotor angle measurement or injecting q-axis current; and
command the inverter to inject a test current pulse to the electric machine.

2. The electrified vehicle of claim 1 wherein the controller is further programmed to generate a diagnostic signal in response to any one of the current sensor signals being less than an associated threshold.

3. The electrified vehicle of claim 2, wherein the position offset is non-zero near rotor positions corresponding to (60*n) degrees where n is an integer between one and six inclusive, and zero otherwise.

4. The electrified vehicle of claim 1 wherein each of the plurality of regularly spaced rotational positions is spaced sixty degrees from an adjacent one of the regularly spaced rotational positions.

5. The electrified vehicle of claim 1 wherein the test current pulse comprises a current less than a maximum current threshold associated with initiation of vehicle motion.

6. The electrified vehicle of claim 5 wherein the test current pulse comprises a current that exceeds a minimum current threshold determined based on a phase current generated by the current pulse in each phase of the three-phase electric machine exceeding a minimum detectable current associated with the corresponding current sensor associated with each phase.

7. An electrified vehicle having a traction battery coupled by an inverter connected to a three-phase electric machine by associated cables with each cable having an associated current sensor, comprising:
a controller configured to apply a position offset to measurements by a rotational position sensor of the three-phase electric machine, to inject a test current to the three-phase electric machine, and to generate a diagnostic signal in response to a signal from the current sensor for any one of the cables being below an associated threshold while injecting the test current.

8. The electrified vehicle of claim 7 wherein the controller applies the position offset in response to rotational position of the three-phase electric machine being within a predetermined range of a zero-phase-current rotational position associated with zero phase current in one of the three-phases.

9. The electrified vehicle of claim 8 wherein the position offset is non-zero near rotor positions corresponding to (60*n) degrees where n is an integer between one and six inclusive, and zero otherwise.

10. The electrified vehicle of claim 9 wherein the controller is further configured to inject a d-axis current pulse in response to detection of traction battery voltage being applied to the inverter.

11. The electrified vehicle of claim 10 wherein the test current is insufficient to induce vehicle motion.

12. The electrified vehicle of claim 10 wherein the test current generates a current in each of the cables above a minimum detection threshold of the associated current sensor.

13. A method for controlling an electrified vehicle having a traction battery coupled to an inverter connected to a three-phase electric machine by associated cables with each cable having an associated current sensor, comprising, by a controller in response to detecting traction battery voltage applied to the inverter:
controlling rotational position or q-axis current of the three-phase electric machine to avoid rotational positions having zero phase current in any of the three phases;
controlling the inverter to inject a test d-axis current to the three-phase electric machine; and
generate a diagnostic signal in response to the current sensor for any one of the three cables indicating current less than an associated threshold while injecting the test current.

14. The method of claim 13 wherein controlling rotational position comprises applying an offset to measurement of a position sensor configured to detect rotational position of the three-phase electric machine.

15. The method of claim 14 wherein the offset is non-zero near rotor positions corresponding to (60*n) degrees where n is an integer between one and six inclusive, and zero otherwise.
